(19) United States
(12) Patent Application Publication
(10) Pub. No.: US 2013/0127356 A1
(43) Pub. Date: May 23, 2013

(54) LED DRIVING POWER SUPPLY APPARATUS AND LED LIGHTING APPARATUS

(71) Applicants: Hideki TANAKA, Nagaokakyo-shi (JP); Kyoichi TAKEMURA, Nagaokakyo-shi (JP)

(72) Inventors: Hideki TANAKA, Nagaokakyo-shi (JP); Kyoichi TAKEMURA, Nagaokakyo-shi (JP)

(73) Assignee: MURATA MANUFACTURING CO., LTD., Nagaokakyo-shi (JP)

(21) Appl. No.: 13/476,096

(22) Filed: May 21, 2012

Related U.S. Application Data
(63) Continuation of application No. PCT/JP2010/060717, filed on Jun. 24, 2010.

(30) Foreign Application Priority Data
Nov. 25, 2009 (JP) 2009-267140

(51) Int. Cl. H05B 37/02

(52) U.S. Cl. CPC H05B 37/02
USPC 315/200 R

(57) ABSTRACT

An LED driving power supply apparatus and an LED lighting apparatus is provided in which stable dimming is realized even when dimming is performed in a range that includes a light-off state. A power conversion control circuit controls the on time or switching period of a switching device in accordance with a feedback control signal input through an insulating member, operates as a PFC converter, and controls power supplied to the LED. A dimming control circuit includes a constant current control circuit, a constant voltage control circuit, and an OR gate circuit. When the external dimming signal is a signal specifying normal lighting, the constant current control circuit maintains a current supplied to the LED at a target current. When the external dimming signal is a signal specifying a minimum luminance, the constant voltage control circuit maintains a voltage applied to the LED at a target voltage.

### BACKGROUND OF THE INVENTION

1. Field of the Invention

The present invention relates to LED driving power supply apparatuses for driving LEDs and LED lighting apparatuses.

2. Description of the Related Art

LEDs are used in various ways, for example, used in lighting apparatuses or to backlight display devices. In general, LED driving circuits that supply power to LEDs are driven through constant current control. This is because the light emission intensity of an LED, which utilizes electron-hole radiative recombination caused by a forward direction current through the p-n junction, is approximately proportional to a supplied current rather than an applied voltage.

Japanese Unexamined Patent Application Publication No. 2008-537459 discloses an LED lighting apparatus having a dimming capability. FIG. 1 is a circuit diagram of an LED driving power supply apparatus disclosed in Japanese Unexamined Patent Application Publication No. 2008-537459.

Referring to FIG. 1, a power converter 10 includes an EMI filter 14, a rectifier 16, and a power block 18. The power converter 10 is supplied with an alternating current (AC) voltage Vac through input terminals thereof, converts the AC voltage into a direct current (DC) voltage Vdc, and supplies a current for driving LEDs 12 to output terminals A and B thereof. The power converter 10 converts a high input AC voltage into a voltage with a desirable level which may be higher or lower than that of the AC input subsequent to rectification. Thereby, an LED current can be appropriately controlled to realize a desirable luminance level. Further, an AC input current is synchronized with an AC input voltage.

When the luminance of an LED lighting apparatus is to be suppressed through dimming, a driving current needs to be decreased. However, as the driving current of an LED lighting apparatus is decreased, the current flowing through the LED becomes very small near the lower limit of a dimmable range, whereby the LED current becomes unstable. Hence, flickering occurs when dimming is performed in a range that includes a light-off state.

The instability of an LED current is caused by constant current control. In other words, constant current control requires current feedback from an LED lighting apparatus, and when the LED current becomes very small, the amount of current feedback becomes insufficient. Hence, the LED current is excessively increased until the minimum amount of current feedback required for an operation is obtained, whereby feedback control is performed. However, this feedback control causes an excessive decrease in the LED current, whereby the LED current is again excessively increased. Repetition of such control generates the flickering described above.

### SUMMARY OF THE INVENTION

Hence, preferred embodiments of the present invention provide an LED driving power supply apparatus and an LED lighting apparatus in which stable dimming is realized even when dimming is performed in a range that includes a light-off state.

An LED lighting apparatus according to a preferred embodiment of the present invention includes an LED driving power supply apparatus and an LED driven thereby. The LED driving power supply apparatus preferably includes a power conversion circuit that receives power from an input power supply and outputs power to an LED; a first control circuit that controls the power conversion circuit in accordance with a feedback control signal to control power supplied to the LED; and a second control circuit that receives an external dimming signal to set a luminance of the LED or power supplied to the LED and that outputs the feedback control signal to the first control circuit.

The second control circuit preferably includes a constant current control circuit that maintains an output current (current supplied to the LED) from the power conversion circuit at a target current when the external dimming signal is a signal that specifies normal lighting; and a constant voltage control circuit that maintains an output voltage (voltage supplied to the LED) from the power conversion circuit at a target voltage when the external dimming signal is a signal that specifies a minimum luminance, and the constant voltage control circuit outputs the feedback signal so that the first control circuit outputs a voltage that is lower than or equal to an offset voltage (light-on/light-off threshold voltage) of the LED and that is higher than or equal to a lower limit voltage at which the second control circuit is capable of operating.

With this unique configuration according to the present preferred embodiment of the present invention described above, the LED is dimmed in a constant-current-driven manner when the external dimming signal is a signal that specifies normal lighting, and a stable voltage is applied through constant voltage control when the external dimming signal is a signal that specifies a minimum luminance.

For example, the input power supply may be a commercial AC power supply. The power conversion circuit is supplied with a voltage of the commercial AC power supply, and preferably is a power factor correction converter that supplies the LED with a current that changes like a sine wave having the same phase as the voltage of the commercial AC power supply.

In another example, the input power supply is a commercial AC power supply, the power conversion circuit is supplied with a voltage of the commercial AC power supply and includes a transformer that converts power in an insulated manner.

The LED driving power supply apparatus according to a preferred embodiment of the present invention preferably further includes a constant voltage control circuit target value switch.

The constant current control circuit and the constant voltage control circuit operate together, and either an output of the constant current control circuit or an output of the constant voltage control circuit, whichever lowers the power supplied to the LED, is preferentially supplied to the first control circuit as the feedback control signal. The constant voltage control circuit target value switch sets the target voltage for the constant voltage control circuit to a first target value so as to make the output of the constant current control circuit be effective when the external dimming signal is a signal that specifies normal lighting, and sets the target voltage for the constant voltage control circuit to a second target value that is lower than the first target value so as to make the output of the constant voltage control circuit be effective when the external dimming signal is a signal that specifies the minimum luminance.

With this configuration, since there is no need to stop one of the constant current control circuit and the constant voltage control circuit, a selection circuit is not required.

For example, the first target value is determined so as to make the output of the constant voltage control circuit be effective when the output current (current supplied to the LED) from the power conversion circuit is below the target current.

With this configuration, the output voltage at the time of an open load is limited to the first target voltage, thereby enabling overvoltage protection.

In another example, the target voltage is made to have a value that is lower than the lower limit voltage at which the second control circuit is capable of operating, and when the external dimming signal is a signal that specifies the minimum luminance, the external dimming signal is a signal that specifies the minimum luminance, the power conversion circuit alternately and repeatedly increases the output voltage upon termination of an operation of the second control circuit and decreases the output voltage upon the operation of the second control circuit.

With this configuration, since the output voltage can be maintained in a range of lower voltages, power consumption during a light-off period is reduced.

According to various preferred embodiments of the present invention, an LED driving power supply apparatus and an LED lighting apparatus are provided in which stable dimming is realized even when dimming is performed in a range that includes a light-off state.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a circuit diagram of an LED driving power supply apparatus disclosed in Japanese Unexamined Patent Application Publication No. 2008-537459.

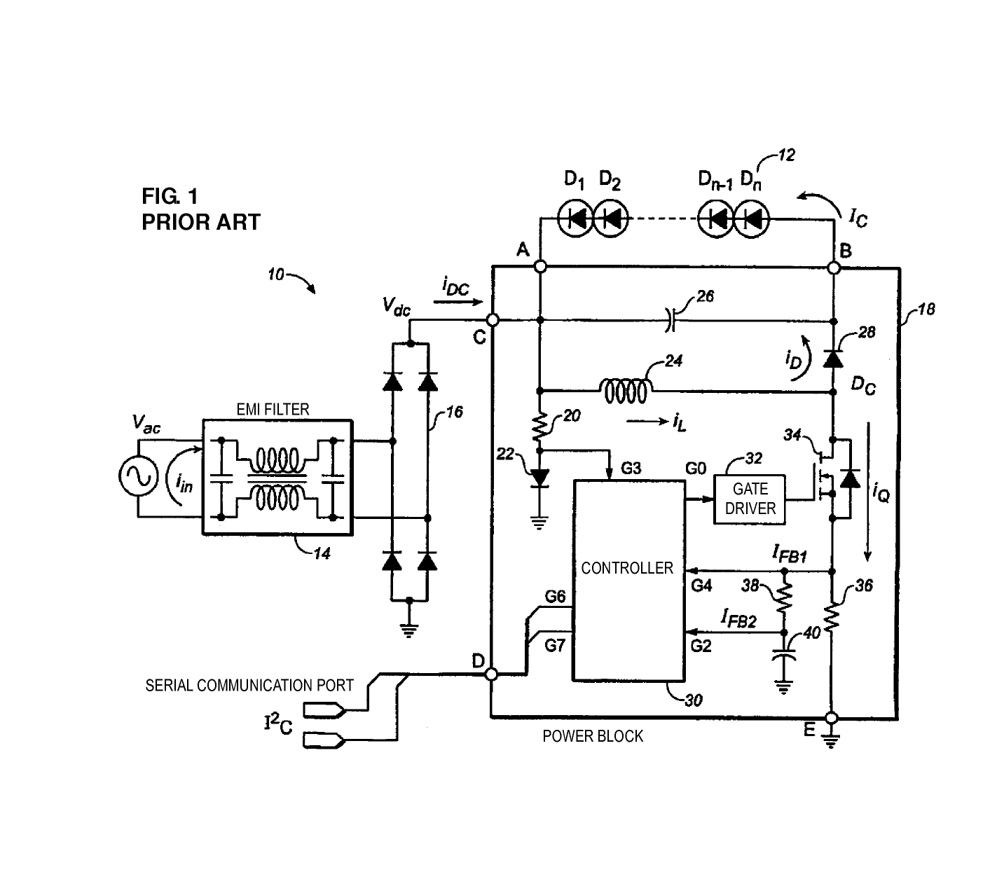

FIG. 2 is a circuit diagram of an LED driving power supply apparatus 101 and an LED lighting apparatus including the LED driving power supply apparatus 101 and an LED 60.

FIG. 3 is a diagram illustrating a specific circuit configuration of a dimming control circuit 50 illustrated in FIG. 2.

FIG. 4 illustrates waveform diagrams of portions illustrated in FIGS. 2 and 3.

FIG. 5 illustrates waveform diagrams of portions illustrated in FIGS. 2 and 3.

FIG. 6 illustrates waveform diagrams of portions of an LED driving power supply apparatus according to a second preferred embodiment of the present invention.

### DETAILED DESCRIPTION OF THE PREFERRED EMBODIMENTS

### First Preferred Embodiment

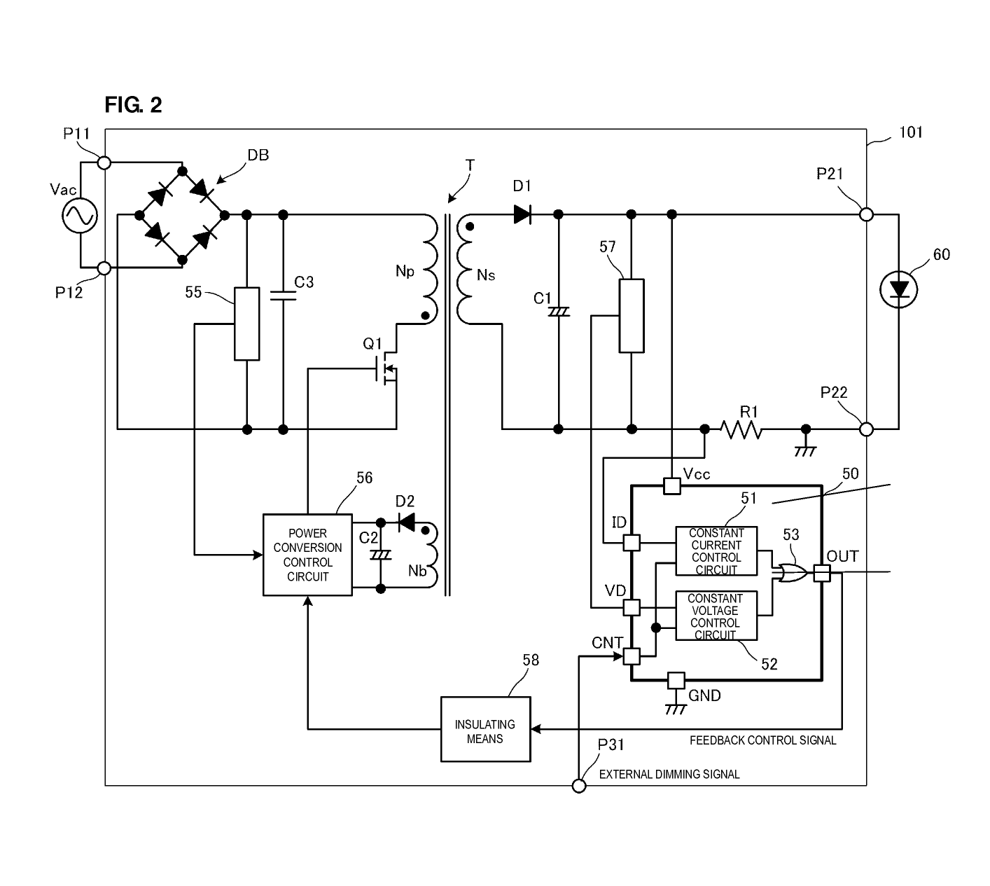

An LED driving power supply apparatus and an LED lighting apparatus according to a first preferred embodiment will be described with reference to FIG. 2 to FIG. 4.

FIG. 2 is a circuit diagram of an LED driving power supply apparatus 101 and an LED lighting apparatus including the LED driving power supply apparatus 101 and an LED 60.

In this example, the LED driving power supply apparatus 101 is supplied with a voltage of a commercial AC power supply Vac through power supply input terminals P11 and P12, and supplies DC power to the LED 60 connected to power supply output terminals P21 and P22. The LED driving power supply apparatus 101 preferably is a PFC (power factor correction converter).

A diode bridge DB performs full-wave rectification of an AC voltage input at the power supply output terminals P21 and P22. A series circuit including a primary winding Np of a transformer T and a switching device Q1 is connected to the output of the diode bridge DB. In addition, a capacitor C3 to remove noise and an input voltage detection circuit 55 are connected to the output of the diode bridge DB.

A rectifying and smoothing circuit including a diode D1 and a capacitor C1 is connected to a secondary winding Ns of the transformer T. An output voltage detection circuit 57 is connected to the output of this rectifying and smoothing circuit. A resistor R1 to detect a current is connected in series with a current path of the LED 60, which is a load.

A rectifying and smoothing circuit including a diode D2 and a capacitor C2 is connected to an auxiliary winding Nb of the transformer T. The output voltage of this rectifying and smoothing circuit is supplied to a power conversion control circuit 56 as a power supply.

The diode bridge DB, the transformer T, the switching device Q1, the diode D1, and the capacitor C1 define a power conversion circuit.

The power conversion control circuit 56, which corresponds to a first control circuit according to a preferred embodiment of the present invention, controls the power conversion circuit by performing on/off driving of the switching device Q1. The power conversion control circuit 56 controls the on time or on duty of the switching device Q1 in accordance with a detection voltage of the input voltage detection circuit 55, so as to change the current flowing through the power supply input terminals P11 and P12 to be approximately a sine wave having the same phase as the voltage of the commercial AC power supply Vac, thereby realizing the operation of a PFC.

Further, the power conversion control circuit 56 controls the on time or switching period of the switching device Q1 in accordance with a feedback control signal input through an insulating member 58, thereby controlling power supplied to the LED 60.

The dimming control circuit 50, which corresponds to a second control circuit of a preferred embodiment of the present invention includes a constant current control circuit 51, a constant voltage control circuit 52, and an OR gate circuit 53. A drop voltage across the resistor R1 for current detection is input to a current detection terminal ID, and a detection voltage of the output voltage detection circuit 57 is input to a voltage detection terminal VD. An external dimming signal is input to a control terminal CNT. A feedback control signal is output from an output terminal OUT to the power conversion control circuit 56 through the insulating member 58 which may be a photocoupler, for example.

The constant current control circuit 51 generates a voltage signal to be supplied to the power conversion control circuit 56 in accordance with an error between a voltage input at the current detection terminal ID and a voltage, which varies in accordance with an external dimming signal, input at the control terminal CNT. In other words, the constant current control circuit 51 performs control such that a current supplied to the LED 60 is maintained below or equal to a target current that is determined by the external dimming signal.

The constant voltage control circuit 52 generates a voltage signal to be supplied to the power conversion control circuit 56 in accordance with an error between a voltage that is input at the voltage detection terminal VD and a target voltage that is switched in accordance with a voltage of the external dimming signal input at the control terminal CNT. In other words, the constant voltage control circuit 52 performs control such that a voltage applied to the LED 60 is maintained below or equal to a target voltage.

In the present preferred embodiment, either the output voltage of the constant current control circuit 51 or the output voltage of the constant voltage control circuit 52, whichever lowers the power supplied to the LED 60, is preferentially supplied to the power conversion control circuit 56 as a feedback signal.

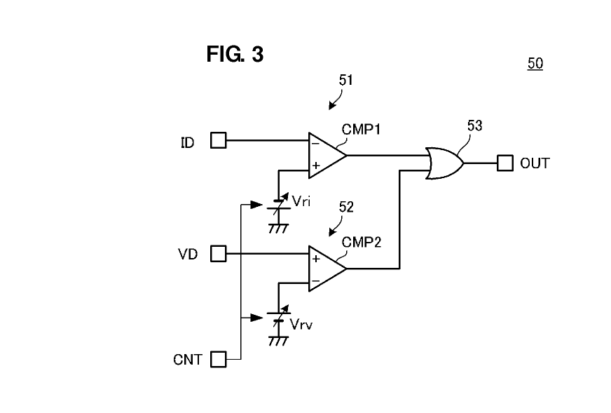

FIG. 3 illustrates a specific circuit configuration of the dimming control circuit 50. The constant current control circuit 51 and the constant voltage control circuit 52 respectively include comparators CMP1 and CMP2, and reference voltage generation circuits Vri and Vrv. The outputs of the constant current control circuit 51 and the constant voltage control circuit 52 are supplied to the OR gate circuit 53.

The comparator CMP1 compares the voltage of the reference voltage generation circuit Vri and the input voltage of the current detection terminal ID, and outputs a high-level voltage when the input voltage of the current detection terminal ID is a negative voltage higher (having a higher absolute value) than the reference voltage Vri. When the voltage of the output terminal OUT is high, the power supplied to the LED 60 is controlled to be suppressed. When the power supplied to the LED is decreased, the input voltage of the current detection terminal ID decreases (the absolute value of the voltage decreases). Hence, feedback control is performed such that the input voltage of the current detection terminal ID maintains the voltage of the reference voltage Vri, whereby constant current control is performed.

The reference voltage Vri changes in accordance with the duty of the external dimming signal input to the control terminal CNT. When the duty of the external dimming signal is 0%, the reference voltage Vri becomes the highest negative voltage (voltage having the highest absolute value). Hence, at this time, the lighting level becomes maximum. When the duty of the external dimming signal is 100%, the reference voltage Vri becomes the lowest negative voltage (voltage having the lowest absolute value). Hence, at this time, performance of lighting is stopped. Since the reference voltage Vri changes in accordance with the change in the duty of the external dimming signal, dimmed lighting is performed.

The comparator CMP2 compares the voltage of the reference voltage generation circuit Vry and the input voltage of the voltage detection terminal VD, and outputs a high voltage when the input voltage of the voltage detection terminal VD is higher than the reference voltage Vrv. When the voltage of the output terminal OUT is high, the power supplied to the LED 60 is controlled to be suppressed. When the power supplied to the LED is decreased, the input voltage of the voltage detection terminal VD decreases. Hence, feedback control is performed such that the input voltage of the voltage detection terminal VD maintains the voltage of the reference voltage Vrv, whereby constant voltage control is performed.

The reference voltage Vry changes in accordance with the duty of the external dimming signal input to the control terminal CNT. When the duty of the external dimming signal is 0% or higher and below about 90%, the reference voltage Vry becomes about 40V, for example. However, constant current control is preferentially used in this duty range and, hence, constant voltage control is not performed. When the duty of the external dimming signal is about 90% or higher, the reference voltage Vry is switched to about 10 V, for example. At this time, constant voltage control is preferentially used and constant voltage control is performed such that about 10 V, for example, is applied to the LED 60. Since this voltage is lower than the offset voltage of the LED 60, the LED 60 enters a turned-off state.

A constant voltage control circuit target value switch according to a preferred embodiment of the present invention switches the reference voltage Vry in accordance with the external dimming signal.

The OR gate circuit 53 outputs a high voltage when either of the output levels of the comparators CMP1 and CMP2 becomes high. Hence, in either of the constant current control or constant voltage control, feedback control is performed such that the power supplied to the LED 60 is suppressed.

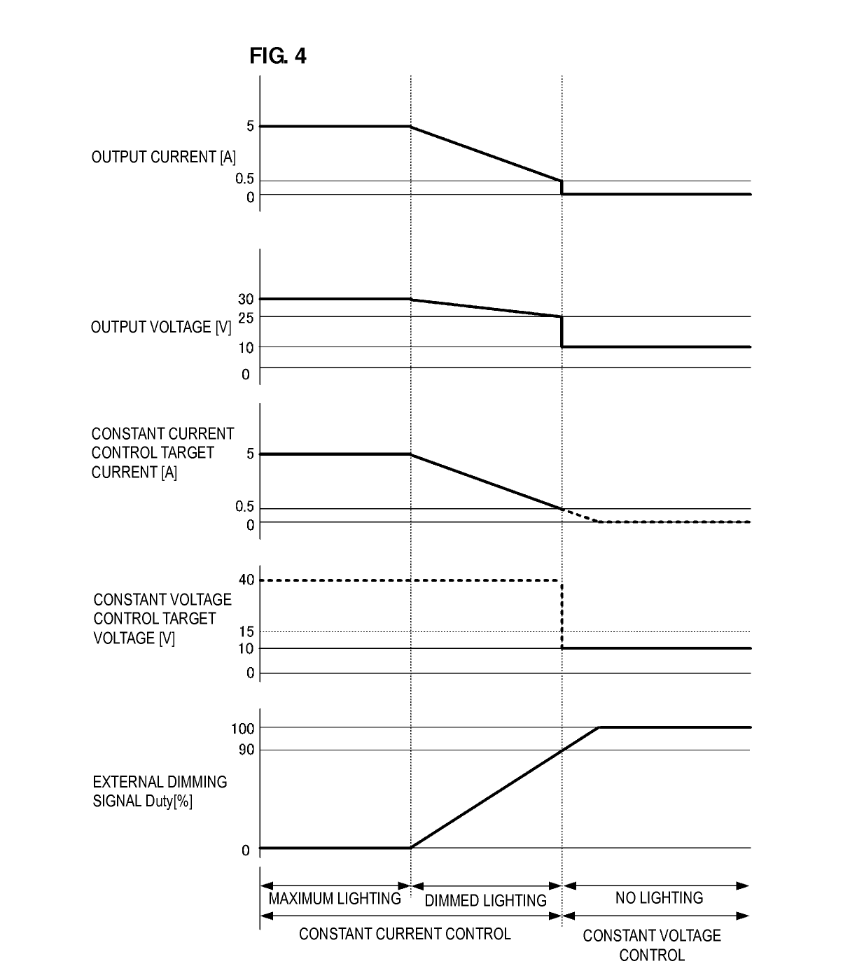

FIG. 4 illustrates waveform diagrams of portions illustrated in FIGS. 2 and 3. When the duty of the external dimming signal is 0%, the LED 60 emits light at the maximum luminance (maximum lighting), and when the duty of the external dimming signal is about 90% or higher, the LED 60 is turned off. For the external dimming signal with a duty between 0% and about 90%, the luminance of the LED 60 decreases as the duty increases.

As has been described above, the target current of the constant current control circuit 51 changes in accordance with the duty of the external dimming signal. Hence, during normal lighting, such as maximum lighting or dimmed lighting, constant current control is performed at a current corresponding to the duty of the external dimming signal.

On the other hand, the target voltage for the constant voltage control circuit 52 is preferably set to about 40 V when the duty of the external dimming signal is below about 90%, and is preferably switched to about 10 V (set to a low value) when the duty of the external dimming signal is about 90% or higher, for example. Hence, the output voltage of the constant voltage control circuit 52 decreases when the duty of the external dimming signal becomes about 90% or higher, for example.

The target voltage is preferably set to about 10 V to make the output voltage in the constant voltage control state be lower than the offset voltage of the LED 60 (for example, about 15 V), for example. Hence, the LED 60 is turned off when the constant current control is switched to the constant voltage control. Since a voltage (about 10 V) lower than the offset voltage (Voffset) is stably applied in the constant voltage control state, a light-off state without flickering is maintained.

As has been described above, even when the duty of the external dimming signal is changed from 0% to about 100%, an LED is driven through constant current control while the LED is on and a voltage is applied through constant voltage control when the LED is off. Hence, stable feedback control is always performed, thereby preventing generation of flickering.

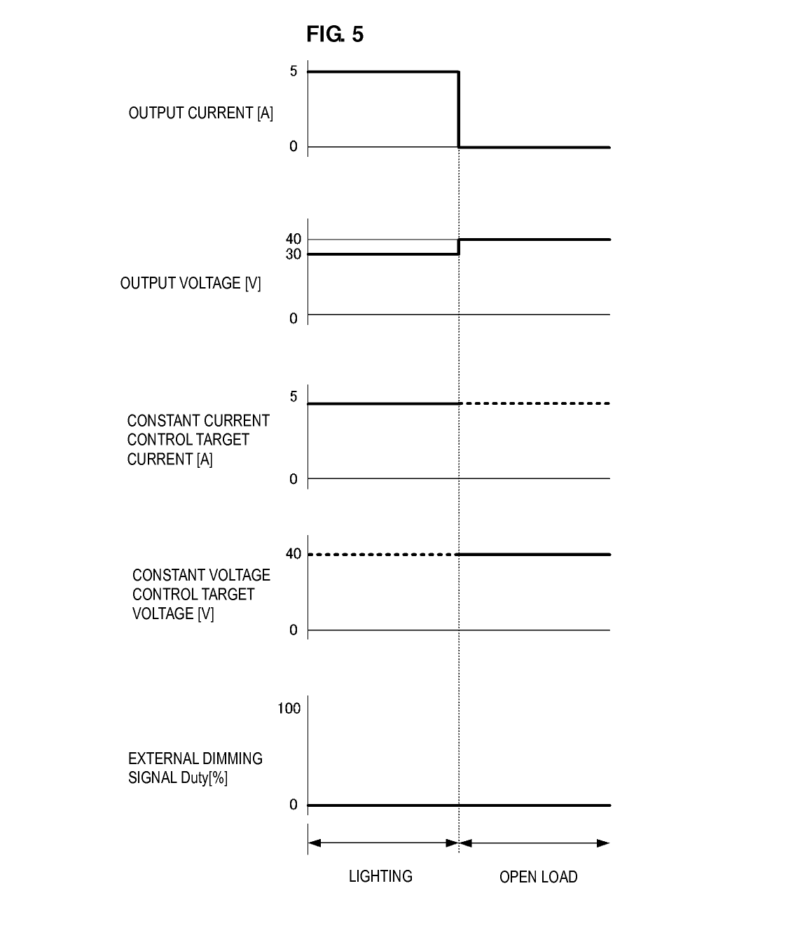

FIG. 5 illustrates waveform diagrams of portions illustrated in FIGS. 2 and 3. This figure illustrates an overvoltage protection function for the time when the LED driving power supply apparatus 101 operates in a state where the LED 60 is open (no load is connected) for some reason.

When the LED 60 is emitting maximum light in a state where the LED 60 is connected, the target voltage for the constant voltage control circuit 52 preferably is about 40 V, for example. The target current for the constant current control circuit 51 is about 5 A and the voltage applied to the LED 60 is about 30 V. Hence, when the LED 60 is in a normal lighting state in a state where the LED 60 is connected, the LED 60 is driven at a constant current through constant current control, as has been described above.

If the LED 60 is removed while the LED driving power supply apparatus 101 is in operation, control through the constant current control circuit 51 becomes impossible because the current supplied to the LED 60 becomes zero. Hence, the constant voltage control circuit 52 functions effectively and the output voltage at the power supply output terminals P21 and P22 becomes about 40 V, which is the target voltage, for example.

In this manner, even when the LED driving power supply apparatus 101 operates in a state where the LED 60 is not connected, a voltage over 40 V is not applied to the power supply output terminals P21 and P22. That is, overvoltage protection is realized.

### Second Preferred Embodiment

A second preferred embodiment is related to an LED driving power supply apparatus that allows power consumption to be reduced while an LED is in a turned-off state.

The configuration of an LED driving power supply apparatus according to the second preferred embodiment is similar to that illustrated in FIG. 2.

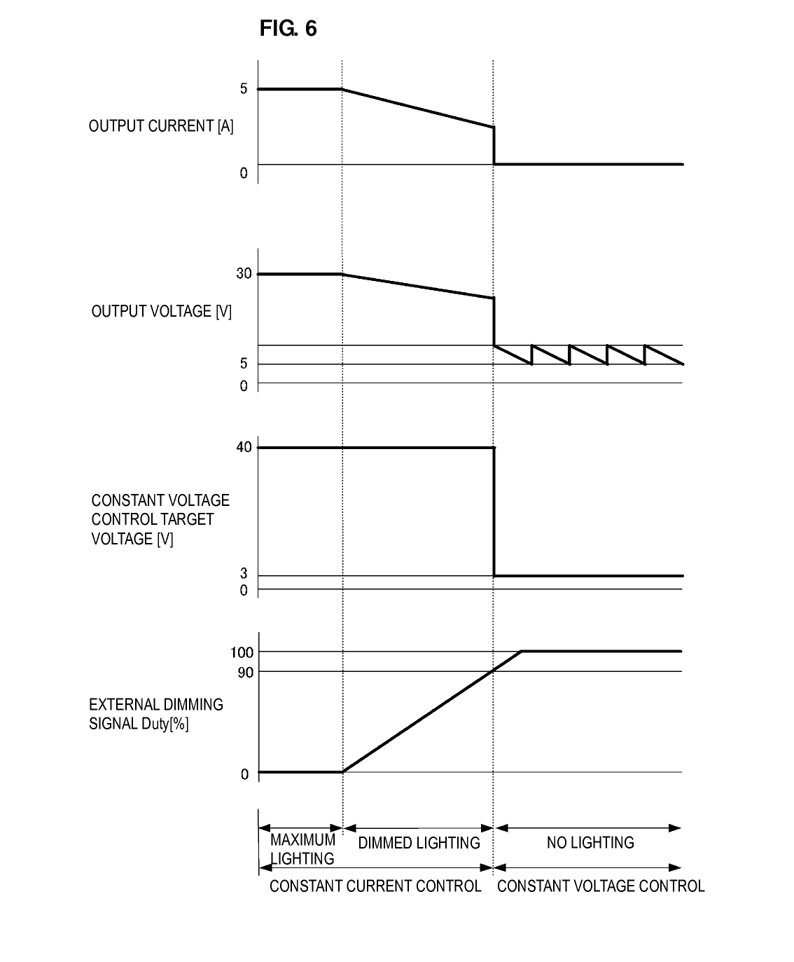

FIG. 6 illustrates waveform diagrams of portions of the LED driving power supply apparatus according to the second preferred embodiment. The state of constant current control is similar to that in the first preferred embodiment. Further, when the duty of an external dimming signal is about 90% or higher, for example, the output of the constant voltage control circuit becomes effective as in the first preferred embodiment. Unlike the first preferred embodiment, the target voltage for the constant voltage control circuit 52 is set considering the operation start voltage and a lower limit voltage at which the dimming control circuit 50 can operate.

The target voltage for the constant voltage control circuit 52 is preferably set to a low value (e.g., about 3 V), which is lower than the lower limit voltage (e.g., about 5 V in the example of FIG. 6) at which the dimming control circuit 50 can operate, for example. Hence, when the duty of the external dimming signal becomes about 90% or higher, for example, the output voltage at the power supply output terminals P21 and P22, i.e., the power supply voltage applied to a power supply terminal Vcc of the dimming control circuit 50 decreases toward 3 V, which is the target voltage. When the power supply voltage of the dimming control circuit 50 becomes below about 5 V, for example, the dimming control circuit 50 temporarily stops its operation. Thereby, supply of a feedback control signal from the dimming control circuit 50 to the power conversion control circuit 56 is stopped, whereby the power conversion control circuit 56 operates in an open loop mode. In other words, since there is no negative feedback, the output voltage at the power supply output terminals P21 and P22 increases.

When the output voltage at the power supply output terminals P21 and P22 reaches a voltage at which the dimming control circuit 50 can operate, the dimming control circuit 50 operates again, whereby negative feedback is realized and the output voltage deceases again toward 3 V, which is the target voltage, for example.

Referring to FIG. 6, in the light-off state, the above-described operation is repeated, whereby the output voltage is maintained in a range of very low voltages. Hence, power consumption during a light-off period is reduced.

Note that although the LED driving power supply apparatus preferably includes an insulating converter that uses a transformer, the LED driving power supply apparatus may include a chopper circuit that does not use a transformer, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An LED driving power supply apparatus comprising:
a power conversion circuit that receives power from an input power supply and outputs power to an LED;
a first control circuit that controls the power conversion circuit in accordance with a feedback control signal to control power supplied to the LED; and
a second control circuit that receives an external dimming signal to set a luminance of the LED or power supplied to the LED and outputs the feedback control signal to the first control circuit; wherein
the second control circuit includes:
a constant current control circuit that maintains an output current from the power conversion circuit at a target current when the external dimming signal is a signal that specifies normal lighting; and
a constant voltage control circuit that maintains an output voltage from the power conversion circuit at a target voltage when the external dimming signal is a signal that specifies a minimum luminance; wherein
the constant voltage control circuit outputs the feedback signal so that the first control circuit outputs a voltage that is lower than or equal to an offset voltage of the LED and that is higher or equal to a lower limit voltage at which the second control circuit is capable of operating.

2. The LED driving power supply apparatus according to claim 1, wherein the input power supply is a commercial AC power supply, and the power conversion circuit is supplied with a voltage of the commercial AC power supply, and is a power factor correction converter that supplies the LED with a current that changes in correspondence to a sine wave having the same phase as the voltage of the commercial AC power supply.

3. The LED driving power supply apparatus according to claim 1, wherein the input power supply is a commercial AC power supply, and the power conversion circuit is supplied with a voltage of the commercial AC power supply and includes a transformer that converts power in an insulated manner.

4. The LED driving power supply apparatus according to claim 1, further comprising a constant voltage control circuit target value switch, wherein the constant current control circuit and the constant voltage control circuit operate together, either an output of the constant current control circuit or an output of the constant voltage control circuit, whichever lowers the power supplied to the LED, is preferentially supplied to the first control circuit as the feedback control signal, and the constant voltage control circuit target value switch sets the target voltage for the constant voltage control circuit to a first target value so as to make the output of the constant current control circuit be effective when the external dimming signal is a signal that specifies normal lighting, and sets the target voltage for the constant voltage control circuit to a second target value that is lower than the first target value so as to make the output of the constant voltage control circuit be effective when the external dimming signal is a signal that specifies the minimum luminance.

5. The LED driving power supply apparatus according to claim 4, wherein the first target value is determined so as to make the output of the constant voltage control circuit be effective when the output current from the power conversion circuit is below the target current.

6. The LED driving power supply apparatus according to claim 4, wherein the target voltage is made to have a value that is lower than the lower limit voltage at which the second control circuit is capable of operating, and when the external dimming signal is a signal that specifies the minimum luminance, the power conversion circuit alternately and repeatedly increases the output voltage upon termination of an operation of the second control circuit and decreases the output voltage upon the operation of the second control circuit.

7. An LED lighting apparatus comprising:
the LED driving power supply apparatus according to claim 1; and
an LED that is supplied with power from the LED driving power supply apparatus.
